(19) United States
(12) Patent Application Publication
(10) Pub. No.: US 2019/0170034 A1
(43) Pub. Date: Jun. 6, 2019

(54) COMPACT DEVICE FOR PURIFICATION AND RECIRCULATION OF EXHAUST GAS

(71) Applicant: FAURECIA SYSTEMES D'ECHAPPEMENT, NANTERRE (FR)

(72) Inventors: Yannick GODARD, BLUSSANS (FR); Edouard NAULIN, BELFORT (FR); Benjamin OBLINGER, MONTBELIARD (FR); Thierry MARIMBORDES, ESSERT (FR)

(21) Appl. No.: 16/202,176

(22) Filed: Nov. 28, 2018

(30) Foreign Application Priority Data
Dec. 4, 2017 (FR) 1761588

(51) Int. Cl. F01N 3/02; F02B 37/02; F01N 3/033; F01N 13/18; F01N 13/08; B01D 39/20; B01D 46/42

(52) U.S. Cl. CPC F01N 3/0205; F02B 37/02; F01N 3/033; F01N 13/1888; B01D 2279/30; B01D 39/2027; B01D 46/4263; F01N 2260/02; F01N 2470/00; F01N 13/087

(57) ABSTRACT

The device includes an upstream pipe, extending along a first direction, and in which at least one purification member is housed, a first downstream pipe, extending along a second direction, and in which at least one heat exchanger is housed, and a second downstream pipe configured to be connected to an exhaust gas outlet tube. The device also includes an intermediate chamber comprising an exhaust gas inlet communicating with the upstream pipe, downstream from the at least one purification member, a first exhaust gas outlet communicating with the first downstream pipe, and a second exhaust gas outlet communicating with the second downstream pipe. The first direction and the second direction form an angle between them comprised between 0° and 90°.

### CROSS-REFERENCE TO RELATED APPLICATIONS

This application claims priority to FR 17 61588, filed 4 Dec. 2017.

### FIELD OF INVENTION

The present invention relates to an exhaust gas purification and recirculation device, in particular for a motor vehicle exhaust system.

### BACKGROUND OF THE INVENTION

An exhaust gas purification and recirculation device is in particular intended to reduce fuel consumption in a heat engine, particularly for a motor vehicle.

Such a purification and recirculation device known in the state of the art, in particular according to FR 3,041,033 A1, is relatively cumbersome, such that its integration into an exhaust line can be difficult to implement.

### SUMMARY OF THE INVENTION

The invention in particular aims to resolve this drawback, by providing a compact device for the purification and recirculation of exhaust gas.

To that end, the invention in particular relates to an exhaust gas purification and recirculation device, in particular for a motor vehicle exhaust system, including:

an upstream pipe, extending along a first direction X1, and in which at least one exhaust gas purification member is housed;

a first downstream pipe, extending along a second direction X2, and in which at least one heat exchanger is housed;

a second downstream pipe configured to be connected to an exhaust gas outlet tube, and

an intermediate chamber that comprises:

an exhaust gas inlet communicating with the upstream pipe, downstream from the at least one exhaust gas purification member,

a first exhaust gas outlet communicating with the first downstream pipe, and

a second exhaust gas outlet communicating with the second downstream pipe,

and wherein the first direction X1 and the second direction X2 form an angle [symbol] between them comprised between 0° and 90°.

Thus, the upstream pipe and the first downstream pipe extend on a same side of the intermediate chamber, such that the gas purification and recirculation device according to the invention is more compact than a device according to the state of the art, in particular that according to FR 3,041,033 A1.

A device according to the invention may further include one or more of the following features, considered alone or according to any technically possible combinations:

the angle [symbol] formed between the first direction X1 and the second direction is comprised between 0 and 45°, preferably between 0 and 30°, more preferably substantially equal to 0° and still more preferably equal to 0°.

the angle [symbol] formed between the first direction X1 and the second direction X2 is comprised between 45° and 90°.

the intermediate chamber is delimited by a shell formed by an assembly of at least two shell parts attached on one another.

the shell includes a first shell part comprising the exhaust gas inlet and the first exhaust gas outlet, and a second shell part comprising the second exhaust gas outlet.

the first exhaust gas outlet is covered by a filter.

the intermediate chamber includes exhaust gas guide elements arranged to guide a portion of the exhaust gas exiting the exhaust gas inlet toward the first exhaust gas outlet.

the intermediate chamber is at least partly delimited by a shell, the shell comprising a concave side converging toward the second exhaust gas outlet.

a bypass pipe parallel to the first downstream pipe, the bypass pipe being able to be closed by a dedicated valve.

the exhaust gas inlet is arranged across from the second exhaust gas outlet.

### BRIEF DESCRIPTION OF THE DRAWINGS

The invention will be better understood upon reading the following description, provided solely as an example and done in reference to the appended figures, in which:

FIG. 1 is an axial sectional schematic view of a purification and recirculation device according to one example embodiment of the invention;

FIG. 2 is a perspective view of the purification and recirculation device of FIG. 1;

FIG. 3 is a top view of a first shell part delimiting an intermediate chamber of the device of FIG. 1; and

FIG. 4 is a schematic top view of a second shell part delimiting the intermediate chamber of the device of FIG. 1.

### DETAILED DESCRIPTION

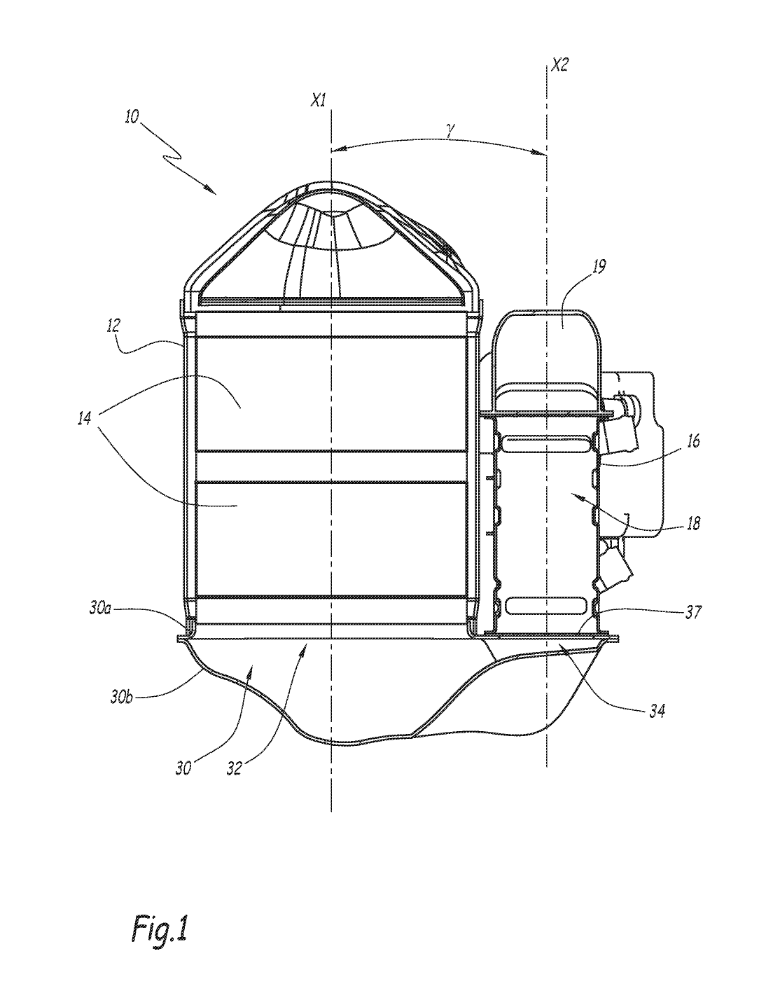

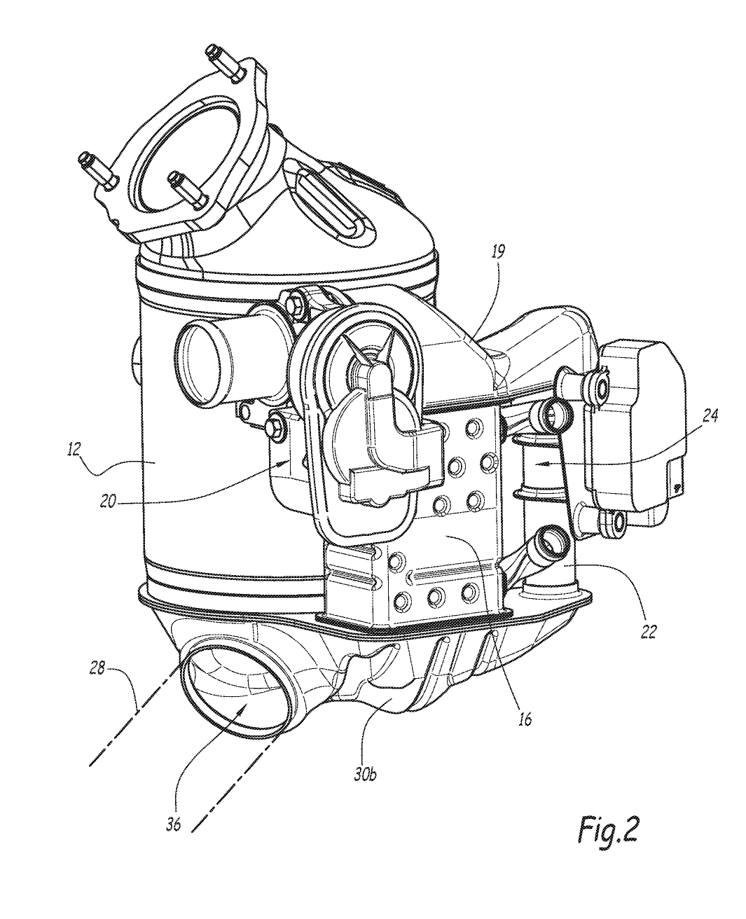

FIGS. 1 and 2 show an exhaust gas purification and recirculation device 10, intended to be arranged in an exhaust system, in particular of a motor vehicle.

The purification and recirculation device 10 includes an upstream pipe 12, extending along a first direction X1. This upstream pipe 12 is, for example, intended to be connected at the outlet of a turbocompressor of the exhaust system, traditionally for a turbocompressed engine or at the outlet of an exhaust manifold for an atmospheric engine. The upstream pipe 12 is, for example, made from stainless steel.

The upstream pipe 12 houses at least one exhaust gas purification member 14, for example two purification members 14 in series.

Thus, the upstream pipe 12 performs a purification function of the purification and recirculation device 10.

The purification and recirculation device 10 further includes a first downstream pipe 16, extending along a second direction X2, and in which at least one traditional heat exchanger 18 is housed. The first downstream pipe 16 is, for example, made from stainless steel.

This first downstream pipe 16 is, for example, intended to be connected at the inlet of the turbocompressor for a turbocompressed engine, or downstream from a butterfly housing for an atmospheric engine, to perform a recirculation function of the purification and recirculation device 10. The heat exchanger 18 is intended, as is known in itself, to decrease the temperature of the exhaust gases below a predefined maximum temperature, generally 160° C., before reinjecting the exhaust gases at the inlet of the turbocompressor or downstream from the butterfly housing.

The first downstream pipe 16 emerges in a downstream hose 19, arranged downstream from the heat exchanger 18. This downstream hose 19 includes a main valve 20, movable between a closing position in which the exhaust gas cannot circulate in the first downstream pipe 16, and a released position in which the exhaust gas can circulate freely in the first downstream pipe 16.

As shown in FIG. 2, the purification and recirculation device 10 optionally includes a bypass pipe 22 substantially parallel, and preferably parallel, to the first downstream pipe 16, also emerging in the downstream hose 19. The exhaust gas circulation in the bypass pipe 22 is therefore conditioned by the position of the main valve 20.

The bypass pipe 22 can further be closed by a dedicated valve 24 of the traditional type. This bypass pipe 22 is intended, as is known in itself, to keep the temperature high enough (for example above 65° C.) and to prevent the formation of condensation in the heat exchanger 18. The dedicated valve 24 is opened or closed based on the temperature of the exhaust gas.

The purification and recirculation device 10 further includes a second downstream pipe 28, intended to be connected to an exhaust gas outlet tube. The second downstream pipe 28 is, for example, made from stainless steel.

The purification and recirculation device 10 includes an intermediate chamber 30 comprising:

an exhaust gas inlet 32 communicating with the upstream pipe 12, downstream from the purification member 14, and for example directly downstream from the purification member 14,

a first exhaust gas outlet 34 communicating with the first downstream pipe 16, and

a second exhaust gas outlet 36 communicating with the second downstream pipe 28.

It should be noted that the first exhaust gas outlet 34 is advantageously covered by a filter 37. This filter 37 is, for example, formed by a metal net. This filter 37 is intended to prevent the passage of particles, in particular ceramic particles from the purification member(s) 14, toward the turbocompressor for a turbocompressed engine or downstream from the butterfly housing for an atmospheric engine.

According to the invention, the first direction X1 and the second direction X2 form an angle [symbol] between them comprised between 0° and 90°, inclusive.

It should be noted that in the state of the art, the first and second directions are generally aligned, and therefore form an angle of 180°.

An angle of 0° in fact corresponds to parallel first X1 and second X2 directions, as is the case in the example shown in FIG. 1. In this case, the upstream pipe 12 and the first downstream pipe 16 extend parallelly, next to one another.

Preferably, the angle [symbol] formed between the first direction X1 and the second direction X2 is comprised between 0 and 45°.

Advantageously, the angle [symbol] formed between the first direction X1 and the second direction X2 is comprised between 0 and 30°.

More preferably, the angle [symbol] is substantially equal to 0° and still more preferably equal to 0°.

Alternatively, the angle [symbol] formed [between] the first direction and the second direction is comprised between 45° and 90°.

According to one preferred embodiment, the intermediate chamber 30 is at least partially delimited by a shell formed by an assembly of at least two shell parts 30a, 30b attached on one another.

For example, the shell includes:

a first shell part 30a comprising the exhaust gas inlet 32, and the first exhaust gas outlet 34, and

a second shell part 30b comprising the second exhaust gas outlet 36.

Alternatively, the intermediate chamber 30 could be formed by a plurality of shell parts.

The first shell part 30a is shown schematically in FIG. 2, in a bottom view, i.e., from an inside of the intermediate chamber 30.

This first shell part 30a is, for example, substantially planar, but may alternatively have any possible shape. As shown in FIG. 2, the exhaust gas inlet 32 and the first exhaust gas outlet 34 are arranged in this first shell part 30a. Another opening 38, intended to be connected to the bypass pipe 22, is also arranged in the first shell part 30a, near the first exhaust gas outlet 34.

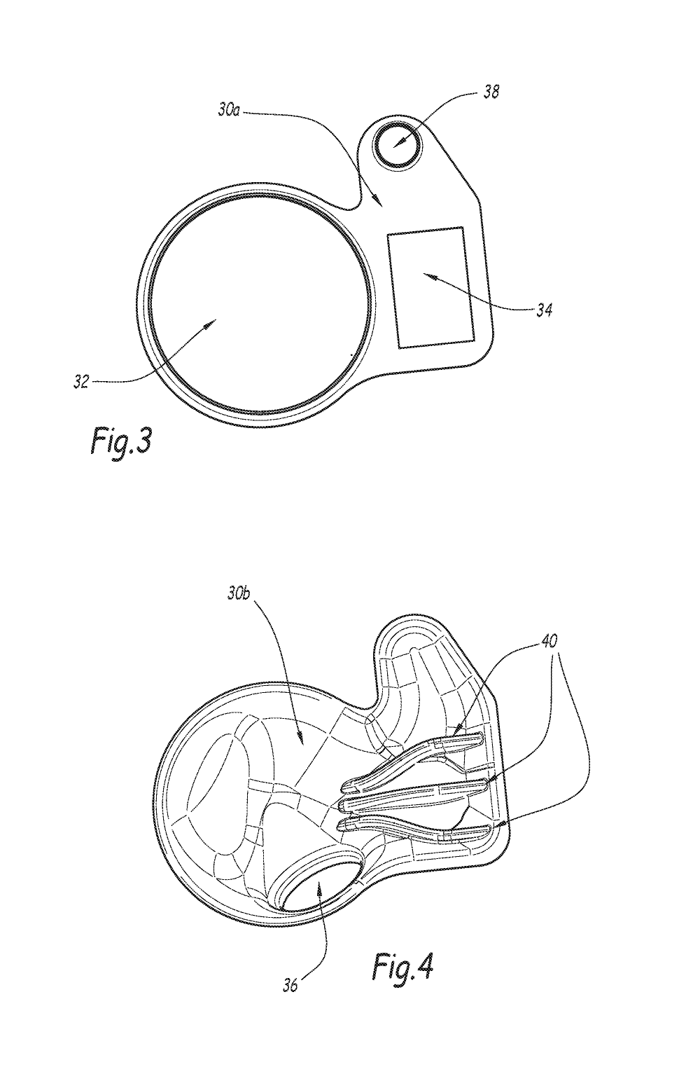

The second shell part 30b is shown schematically in FIG. 3, in a top view, i.e., from the inside of the intermediate chamber 30.

The second shell part 30b preferably has a generally concave shape converging toward the second exhaust gas outlet 36. This concave side is more particularly visible in FIG. 2. Because of this concavity, the exhaust gas in the intermediate chamber 30 is easily guided toward the second exhaust gas outlet 36, in particular when the main valve 20 is in the closing position. In other words, when the main valve 20 is in the closing position, the presence of the first downstream pipe 16 does not hinder the flow of the gas stream toward the second downstream pipe 28, the exhaust gas stream being naturally guided by the concavity toward the second exhaust gas outlet 36.

It should also be noted that the second exhaust gas outlet 36 is preferably arranged across from the exhaust gas inlet 32. This is also preferably the case in other embodiments not limited to two shell parts.

Furthermore, according to the described embodiment, the second shell part 30b bears exhaust gas guiding elements 40.

Alternatively, the exhaust gas guiding elements 40 could be arranged differently in the intermediate chamber 30.

The exhaust gas guide elements 40 are arranged to guide a part of the exhaust gas coming from the inlet toward the first exhaust gas outlet 34. Thus, they are arranged on the second shell part 30b, at least in part substantially across from the first exhaust gas outlet 34. Thus, the gas coming from the upstream pipe 12, arriving on the zone of the second shell part 30b comprising the exhaust gas guiding elements 40, will be guided by these exhaust gas guiding elements 40 toward the first exhaust gas outlet 34.

Although an embodiment of this invention has been disclosed, a worker of ordinary skill in this art would recognize that certain modifications would come within the scope of this disclosure. For that reason, the following claims should be studied to determine the true scope and content of this disclosure.

1. An exhaust gas purification and recirculation device, including:
an upstream pipe, extending along a first direction, and in which at least one exhaust gas purification member is housed;
a first downstream pipe, extending along a second direction, and in which at least one heat exchanger is housed;
a second downstream pipe configured to be connected to an exhaust gas outlet tube; and
an intermediate chamber that comprises an exhaust gas inlet communicating with the upstream pipe, downstream from the at least one exhaust gas purification member, a first exhaust gas outlet communicating with the first downstream pipe, and a second exhaust gas outlet communicating with the second downstream pipe, and wherein the first direction and the second direction form an angle between them comprised between 0° and 90°.

2. The exhaust gas purification and recirculation device according to claim 1, wherein the angle formed between the first direction and the second direction is comprised between 0 and 45°.

3. The exhaust gas purification and recirculation device according to claim 1, wherein the angle formed between the first direction and the second direction is comprised between 0 and 30°.

4. The exhaust gas purification and recirculation device according to claim 1, wherein the angle formed between the first direction and the second direction is equal to 0°.

5. The exhaust gas purification and recirculation device according to claim 1, wherein the angle formed between the first direction and the second direction is comprised between 45° and 90°.

6. The exhaust gas purification and recirculation device according to claim 1, wherein the intermediate chamber is delimited by a shell formed by an assembly of at least two shell parts attached on one another.

7. The exhaust gas purification and recirculation device according to claim 6, wherein the shell includes:
a first shell part comprising the exhaust gas inlet and the first exhaust gas outlet, and
a second shell part comprising the second exhaust gas outlet.

8. The purification and recirculation device according to claim 1, wherein the first exhaust gas outlet is covered by a filter.

9. The exhaust gas purification and recirculation device according to claim 1, wherein the intermediate chamber includes exhaust gas guide elements arranged to guide a portion of exhaust gas exiting the exhaust gas inlet toward the first exhaust gas outlet.

10. The exhaust gas purification and recirculation device according to claim 1, wherein the intermediate chamber is at least partly delimited by a shell, the shell comprising a concave side converging toward the second exhaust gas outlet.

11. The exhaust gas purification and recirculation device according to claim 1, comprising a bypass pipe parallel to the first downstream pipe, the bypass pipe being able to be closed by a dedicated valve.

12. The exhaust gas purification and recirculation device according to claim 1, wherein the exhaust gas inlet is arranged across from the second exhaust gas outlet.

13. A motor vehicle exhaust system comprising:
an exhaust gas purification and recirculation device that includes
an upstream pipe, extending along a first direction, and in which at least one exhaust gas purification member is housed,
a first downstream pipe, extending along a second direction, and in which at least one heat exchanger is housed,
a second downstream pipe configured to be connected to an exhaust gas outlet tube, and
wherein the exhaust gas purification and recirculation device includes an intermediate chamber comprising:
an exhaust gas inlet communicating with the upstream pipe, downstream from the at least one exhaust gas purification member,
a first exhaust gas outlet communicating with the first downstream pipe, and
a second exhaust gas outlet communicating with the second downstream pipe, and wherein the first direction and the second direction form an angle between them comprised between 0° and 90°.
